(19) United States
(12) Patent Application Publication
(10) Pub. No.: US 2009/0153607 A1
(43) Pub. Date: Jun. 18, 2009

(54) LIQUID EJECTING HEAD AND LIQUID EJECTING APPARATUS

(75) Inventor: Kanshi Abe, Yamagata-ken (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/328,610

(22) Filed: Dec. 4, 2008

(30) Foreign Application Priority Data
Dec. 5, 2007 (JP) 2007-315183

(51) Int. Cl. B41J 29/38; B41J 2/045

(52) U.S. Cl. 347/14; 347/70

(57) ABSTRACT

A liquid ejecting head includes diffusion layers provided in areas opposing pressure generation chambers by doping impurities into a portion of a channel forming substrate, a detecting portion which detects variations in resistance values of the diffusion layers due to the deformation of vibration plates, and an adjustment portion which adjusts driving voltages applied to pressure generation elements on the basis of the detected result of the detecting portion. Accordingly, it is possible to acquire the displacement amounts of the vibration plates due to the driving of the pressure generation elements, by detecting the variations in resistance values of the diffusion layers due to the deformation of the vibration plates.

### CROSS REFERENCES TO RELATED APPLICATIONS

The present invention contains subject matter related to Japanese Patent Application No. 2007-315183 filed in the Japanese Patent Office on Dec. 5, 2007, the entire contents of which are incorporated herein by reference.

### BACKGROUND OF THE INVENTION

1. Field of the Invention

The present invention relates to a liquid ejecting head and a method of manufacturing the same.

2. Description of Related Art

As a representative example of a liquid ejecting head, for example, there is provided a liquid ejecting head including a channel forming substrate, in which pressure generation chambers communicating with nozzles are provided, and piezoelectric elements provided on one surface of this channel forming substrate with vibration plates interposed therebetween. For example, this is disclosed in Japanese Unexamined Patent Application Publication No. 9-254386.

In such a liquid ejecting head, the plurality of pressure generation chambers are arranged in parallel and the plurality of piezoelectric elements corresponding to the pressure generation chambers are provided. In addition, constant voltages are applied to the piezoelectric elements, and the vibration plates are displaced together with the piezoelectric elements so as to apply pressure to the pressure generation chambers, thereby ejecting liquid droplets from the nozzles.

However, although the constant voltages are applied to the piezoelectric elements, a deviation occurs in the displacement amount of the vibration plates corresponding to the pressure generation chambers. That is, a deviation occurs in the ejection amount of the liquid droplets from the nozzles.

### SUMMARY OF THE INVENTION

The invention is contrived to solve the above-described problems and can be realized as the following aspect or application example.

According to an aspect of the invention, there is provided a liquid ejecting head including: a channel forming substrate in which pressure generation chambers communicating with nozzles for ejecting liquid droplets are provided; vibration plates provided on the channel forming substrate so as to configure one surfaces of the pressure generation chambers; pressure generation elements which displace the vibration plates and apply pressure to the insides of the pressure generation chambers; diffusion layers provided in areas opposing the pressure generation chambers by doping impurities into a portion of the channel forming substrate; a detecting portion which detects variations in resistance values of the diffusion layers due to the deformation of the vibration plates; and an adjustment portion which adjusts driving voltages applied to the pressure generation elements on the basis of the detected result of the detecting portion.

Features and advantages of the invention other than the above will become clear by reading the specification with reference to the accompanying drawings.

### BRIEF DESCRIPTION OF THE DRAWINGS

For complete understanding of the invention and the advantages thereof, reference is made to the following description taken in conjunction with the accompanying drawings.

FIG. 1 is an exploded perspective view showing the schematic configuration of a recording head according to Embodiment 1 of the invention.

FIG. 2 is a plan view of the recording head according to Embodiment 1 of the invention.

FIG. 3 is a cross-sectional view of the recording head according to Embodiment 1 of the invention.

FIG. 4 is a view showing a control block of the recording head according to Embodiment 1 of the invention.

FIG. 5 is a plan view showing a modified example of the recording head according to Embodiment 1 of the invention.

FIG. 6 is a cross-sectional view showing a method of manufacturing the recording head according to Embodiment 1 of the invention.

FIG. 7 is a cross-sectional view showing the method of manufacturing the recording head according to Embodiment 1 of the invention.

FIG. 8 is a cross-sectional view of a recording head according to Embodiment 2 of the invention.

FIG. 9 is a cross-sectional view showing a method of manufacturing the recording head according to Embodiment 2 of the invention.

FIG. 10 is a cross-sectional view of a recording head according to Embodiment 3 of the invention.

FIG. 11 is a cross-sectional view showing a method of manufacturing the recording head according to Embodiment 3 of the invention.

FIG. 12 is a schematic view showing an example of a recording apparatus according to an embodiment of the invention.

### DETAILED DESCRIPTION OF PREFERRED ASPECTS

At least the following will become apparent according to the specification and the accompanying drawings. According to an aspect of the invention, there is provided a liquid ejecting head including: a channel forming substrate in which pressure generation chambers communicating with nozzles for ejecting liquid droplets are provided; vibration plates provided on the channel forming substrate so as to configure one surfaces of the pressure generation chambers; pressure generation elements which displace the vibration plates and apply pressure to the insides of the pressure generation chambers; diffusion layers provided in areas opposing the pressure generation chambers by doping impurities into a portion of the channel forming substrate; a detecting portion which detects variations in resistance values of the diffusion layers due to the deformation of the vibration plates; and an adjustment portion which adjusts driving voltages applied to the pressure generation elements on the basis of the detected result of the detecting portion.

According this aspect, the diffusion layers were provided and the variations in resistance values of the diffusion layers due to the displacement of the vibration plates were detected. Since the resistance values of the diffusion layers are increased or decreased by deforming the diffusion layers and changing stress, it is possible to acquire the displacement amounts of the vibration plates due to the driving of the pressure generation elements, by detecting the variations in resistance values of the diffusion layers due to the deformation of the vibration plates. Since the voltages applied to the pressure generation elements are adjusted according to the detected result of the detecting portion, it is possible to uniformize the displacement amounts of the vibration plates configuring the pressure generation chambers. Accordingly, it is possible to uniformize the ejection characteristics of the liquid droplets ejected from the nozzles.

As another aspect of the liquid ejecting head, the diffusion layers may be provided along the longitudinal direction of the pressure generation chambers. In particular, the diffusion layers may be provided in the width-direction central portions of the pressure generation chambers.

Accordingly, the displacement amounts of the diffusion layers due to the displacement of the pressure generation elements become relatively increased, the variation amounts of the resistance values become relatively increased. Thus, it is possible to relatively easily detect the variations in resistance values of the diffusion layers by the detecting portion.

In addition, the diffusion layers may extend from the areas opposing the pressure generation chambers to the outsides of the pressure generation chambers, and the detecting portion may be connected to the portions of the diffusion layers at the outside of the pressure generation chambers. Accordingly, it is possible to prevent the generation of a problem such as a contact failure and to always suitably detect the variations in resistance values of the diffusion layers by the detecting portion, without deforming the portions of the diffusion layers connected to the detecting portion even when the pressure generation elements are driven.

In addition, when the vibration plates include a plurality of insulating layers formed of an insulating material, the diffusion layers may be provided between the insulating layers. Accordingly, the diffusion layers corresponding to the pressure generation chambers are insulated from each other by the insulating layers. Thus, it is possible to more accurately detect the variations in resistance values of the diffusion layers by the detecting portion.

In addition, when the vibration plates include an elastic film formed by thermally oxidizing a silicon substrate, the diffusion layers may be provided on the elastic film at the side of the pressure generation chambers. Accordingly, since the diffusion layers can be relatively easily formed, it is possible to reduce manufacturing cost.

In addition, if the pressure generation elements are piezoelectric elements each having a piezoelectric layer formed of a piezoelectric material, since the displacement of the vibration plates is relatively large, the configuration of the invention in which the diffusion layers are provided is particularly efficient.

In addition, the invention includes a liquid ejecting apparatus comprising the above-described liquid ejecting head. In the invention, since the ejection characteristics of the liquid droplets are uniformized, it is possible to realize a liquid ejecting apparatus with improved reliability.

Hereinafter, the exemplary embodiments of the invention will be described with reference to the accompanying drawings. In addition, the following embodiments are described as examples of the invention, and all the components described herein are not necessary components of the invention.

### BEST EMBODIMENTS

Hereinafter, the embodiments will be described with reference to the drawings.

### Embodiment 1

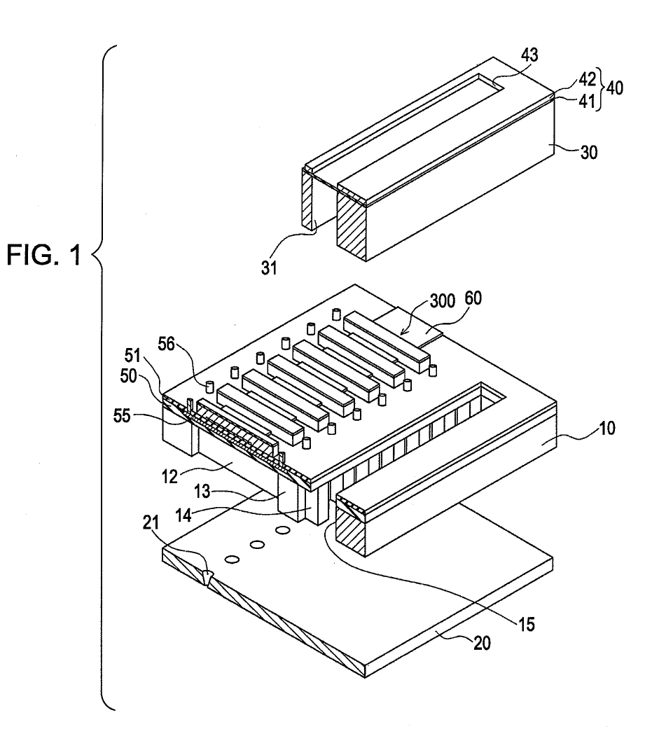

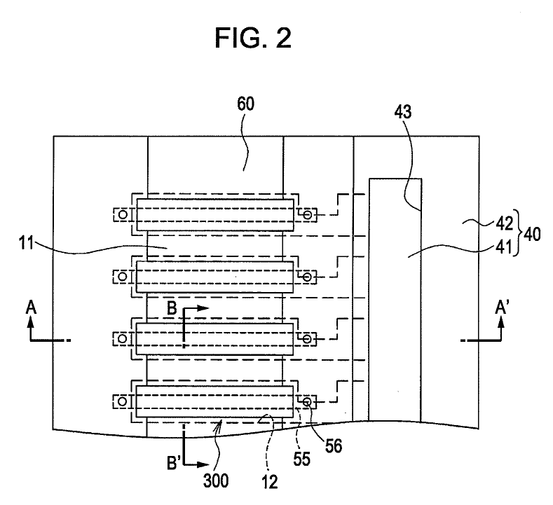

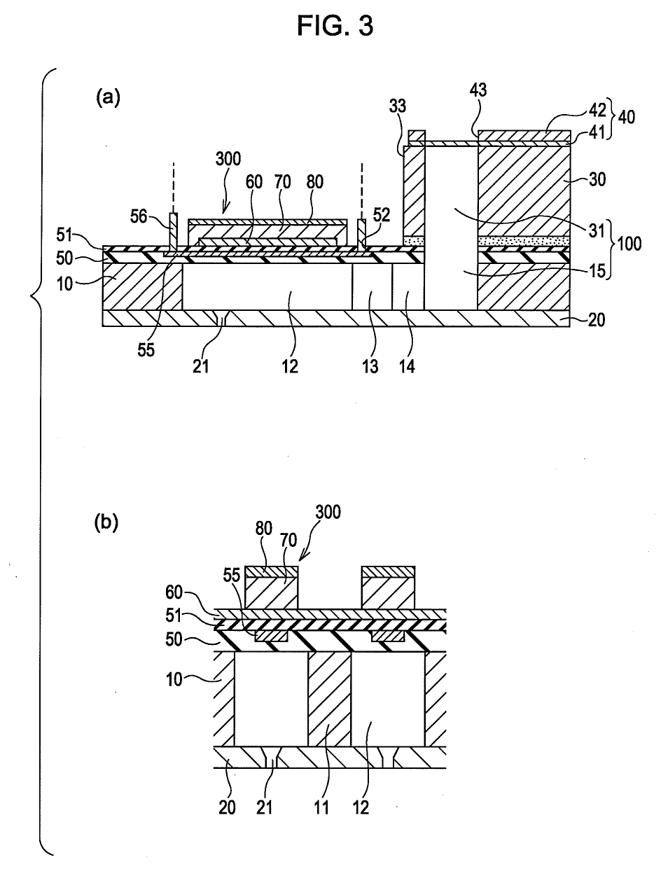

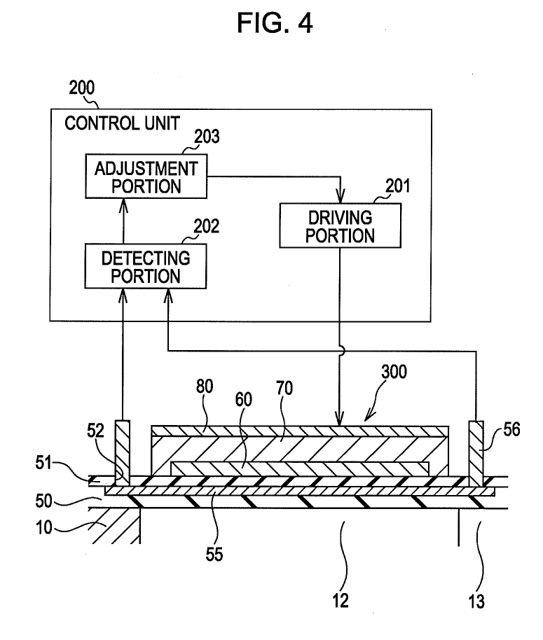

FIG. 1 is an exploded perspective view of a liquid ejecting head according to Embodiment 1 of the invention, FIG. 2 is a plan view thereof, FIG. 3 is a cross-sectional view taken along line A-A′ and B-B′ of FIG. 2, and FIG. 4 is a schematic view showing a control block.

As shown, in the present embodiment, a channel forming substrate 10 is formed of a silicon single crystal substrate (silicon substrate) having a crystal plane orientation (110), and an elastic film 50, which is formed of silicon oxide (SiO₂) and is formed by thermal oxidation in advance, is formed on one surface of the substrate. In the channel forming substrate 10, a plurality of pressure generation chambers 12 partitioned by barrier walls 11 is arranged in parallel along a width direction (a short-side direction).

In addition, ink supply paths 13 and communicating paths 14 partitioned by the barrier walls 11 and communicating with the pressure generation chambers 12 are provided in one end side of the pressure generation chambers 12 of the channel forming substrate 10 in a longitudinal direction. In addition, a communicating portion 15 communicating with the communicating paths 14 is provided outside the communicating paths 14. This communicating portion 15 communicates with a reservoir portion 31 of a below-described reservoir forming substrate 30 and configures a portion of a reservoir 100 which becomes a common ink chamber (a liquid chamber) of the pressure generation chambers 12.

Each of the ink supply paths 13 is formed so as to have a cross-sectional area smaller than that of each of the pressure generation chambers 12 and constantly maintains channel resistance of an ink introduced from the communicating portion 15 to each of the pressure generation chambers 12. For example, in the present embodiment, the ink supply paths 13 narrow the channels of the pressure generation chambers 12 side between the reservoir 100 and the pressure generation chambers 12 in the width direction and have a width smaller than that of the pressure generation chambers 12. In addition, the communicating paths 14 is formed by extending the barrier walls 11 of both sides of the pressure generation chambers 12 in the width direction to the side of the communicating portion 15 and partitioning spaces between the ink supply paths 13 and the communicating portion 15.

A nozzle plate 20, in which nozzles 21 communicating with the vicinity of the end of the opposite side of the ink supply paths 13 of the pressure generation chambers 12 are formed, is adhered to the opened surface side of the channel forming substrate 10 by an adhesive, a hot welding film or the like. In addition, the nozzle plate 20 is, for example, formed of, glass ceramics, a silicon single crystal substrate, stainless steel, or the like.

The elastic film 50 is formed on the side opposite to the opened surface side of the channel forming substrate 10 as described above, and, for example, an insulating film 51 formed of zirconium oxide (ZrO₂) is formed on the elastic film 50. Although will be described in detail later, in the present embodiment, diffusion layers 55 formed by doping impurities into a silicon substrate are provided between the elastic film 50 and the insulating film 51 in correspondence with the pressure generation chambers 12.

On the insulating film 51, piezoelectric elements 300 each including a lower electrode film 60, a piezoelectric layer 70 and an upper electrode film 80 are formed. Generally, each of the piezoelectric elements 300 is formed by using any one of the electrodes as a common electrode and patterning the other electrode and the piezoelectric layer 70 in the pressure generation chambers 12. For example, in the present embodiment, the lower electrode film 60 is used as the common electrode of each of the piezoelectric elements 300 and the upper electrode film 80 is patterned together with the piezoelectric layer 70 so as to be used as an individual electrode of each of the piezoelectric elements 300. However, an opposite configuration may be used according to the state of a driving circuit or a wire.

In addition, the reservoir forming substrate 30 having the reservoir portion 31 configuring at least a portion of the reservoir 100 is adhered on the channel forming substrate 10, on which the piezoelectric elements 300 are formed, by an adhesive. The reservoir portion 31 penetrates through the reservoir forming substrate 30 in a thickness direction, is formed along the arrangement direction of the pressure generation chambers 12, and communicates with the communicating portion 15 of the channel forming substrate 10 as described above so as to configure the reservoir 100 which becomes the common ink chamber of the pressure generation chambers 12.

In addition, a compliance substrate 40 including a sealing film 41 and a fixed plate 42 is adhered on the reservoir forming substrate 30. The sealing film 41 is formed of a flexible material with low rigidity, and one surface of the reservoir portion 31 is sealed by the sealing film 41. In addition, the fixed plate 42 is formed of a rigid material such as metal or the like. Since an area of the fixed plate 42 opposing the reservoir 100 becomes an opened portion 43 which is completely removed in the thickness direction, one surface of the reservoir 100 is sealed by only the sealing film 41 having flexibility.

In the liquid ejecting head of the present embodiment, an ink is introduced from an ink introduction port connected to an external ink supplying unit (not shown), the ink is filled from the reservoir 100 to the nozzles 21, the piezoelectric layer 70 of each of the piezoelectric elements 300 corresponding to the pressure generation chambers 12 are bent so as to deform vibration plates, such that the pressure of the pressure generation chambers 12 is increased so as to eject ink droplets from the nozzles 21. In addition, each of the vibration plates includes all films which are provided below the piezoelectric layer 70 and are deformed together with the piezoelectric layer 70 when a voltage is applied to each of the piezoelectric elements 300. For example, in the present embodiment, the elastic film 50, the insulating film 51, the lower electrode film 60 and the diffusion layers 55 are included in each of the vibration plates.

If the piezoelectric elements 300 are repeatedly driven over a long duration, a phenomenon (aging) in which the deformation is not completely returned to an original state occurs and thus displacement amounts of the vibration plates are reduced. Accordingly, if constant voltages are always applied to the piezoelectric elements 300, a variation occurs in the ejection characteristics (an ejection amount or the like) of the ink droplets ejected from the nozzles 21 of the pressure generation chambers 12. In this embodiment, variations in resistance values of the diffusion layers 55 at a predetermined timing are detected, that is, variations in displacement amounts of the vibration plates are detected, so as to adjust the voltages applied to the piezoelectric elements 300 according to the detected result, thereby uniformizing the ejection characteristics of the ink droplets ejected from the nozzles 21.

The diffusion layers 55 configuring the vibration plates are formed by doping impurities (dopant) into the silicon substrate, and, for example, in the present embodiment, boron is used as the impurities. In addition, the diffusion layers 55 are independently provided in correspondence with the pressure generation chambers 12, and, in the present embodiment, the adjacent diffusion layers 55 are insulated from each other by the elastic film 50 and the insulating film 51 which are the insulating layers formed of an insulating material. As shown in FIG. 2 and FIG. 3(b), the diffusion layers 55 have a width narrower than that of the piezoelectric elements 300 and are formed in the width-direction central portions of the pressure generation chambers 12 along the longitudinal direction. Both ends of each of the diffusion layers 55 extend to the outside of each of the pressure generation chambers 12.

It is preferable that these diffusion layers 55 are relatively thin and, for example, if the elastic film 50 has a thickness 1.0 μm, it is preferable that the diffusion layers have a thickness of 0.5 μm or less. Accordingly, it is possible to suppress the generation of crack in the diffusion layers due to the displacement of the vibration plates.

The diffusion layers 55 are connected to a control unit 200 for controlling the driving of the piezoelectric elements 300 at the outside of the pressure generation chambers 12. In the insulating film 51 of the outer areas of the pressure generation chambers 12, fine holes (trenches) 52 are formed at portions opposing the diffusion layers 55, and, as shown in FIG. 4, the diffusion layers 55 are connected to a detecting portion 202 of the control unit 200 via connection wires 56 disposed in the fine holes 52.

The control unit 200 for controlling the driving of the piezoelectric elements 300 includes a driving portion 201, the detecting portion 202, and an adjustment portion 203. The driving portion 201 applies voltages to the piezoelectric elements 300 on the basis of an external printing signal and selectively drives the piezoelectric elements 300, thereby performing a printing operation. The detecting portion 202 detects variations in resistance values of the diffusion layers 55 due to the driving of the piezoelectric elements 300 at a predetermined timing. In the present embodiment, the variations in the resistance values of the diffusion layers 55 are detected by measuring the resistance values of the diffusion layers 55 before and after the driving of the piezoelectric elements 300.

The adjustment portion 203 adjusts the voltages applied to the piezoelectric elements 300 according to the detected result of the detecting portion 202. That is, when the piezoelectric elements 300 are driven, the voltages applied to the piezoelectric elements 300 are adjusted such that the displacement amounts of the vibration plates configuring the pressure generation chambers 12 are substantially uniformized.

Since the resistance values of the diffusion layers 55 formed by doping boron into the silicon substrate vary according to variations in stress thereof, it is possible to detect the displacement amounts of the vibration plates corresponding to the pressure generation chambers 12 by detecting the variations in resistance values of the diffusion layers 55 due to the driving of the piezoelectric elements 300 by the detecting portion 202. The adjustment portion 203 adjusts the voltages applied to the piezoelectric elements on the detected result of the detecting portion 202, and the driving portion 201 applies the adjusted predetermined voltages to the piezoelectric elements 300, thereby deforming the piezoelectric elements 300.

Accordingly, the displacement amounts of the vibration plates corresponding to the pressure generation chambers 12 due to the driving of the piezoelectric elements 300 are uniformized. Accordingly, the ejection characteristics of the ink droplets ejected from the nozzles 21 communicating with the pressure generation chambers 12 are uniformized so as to improve printing quality. In the present embodiment, in the outer areas of the pressure generation chambers 12, that is, in the areas in which the vibration plates are not vibrated due to the driving of the piezoelectric elements 300, the connection wires 56 are connected to the diffusion layers 55. Accordingly, it is possible to prevent a contact failure between the connection wires 56 and the diffusion layers 55 by the repeated driving of the piezoelectric elements 300.

The method of adjusting the driving voltage by the adjustment portion 203 is not specially limited, but, for example, the driving voltages are adjusted to be high such that the variation amounts of the resistance values of the diffusion layers 55 become a predetermined reference value. If the voltages applied to the piezoelectric elements 300 are adjusted, the driving portion 201 applies the constant voltages to the piezoelectric elements 300 until the detection of the resistance values of the diffusion layers 55 by the detecting portion 202 is next performed.

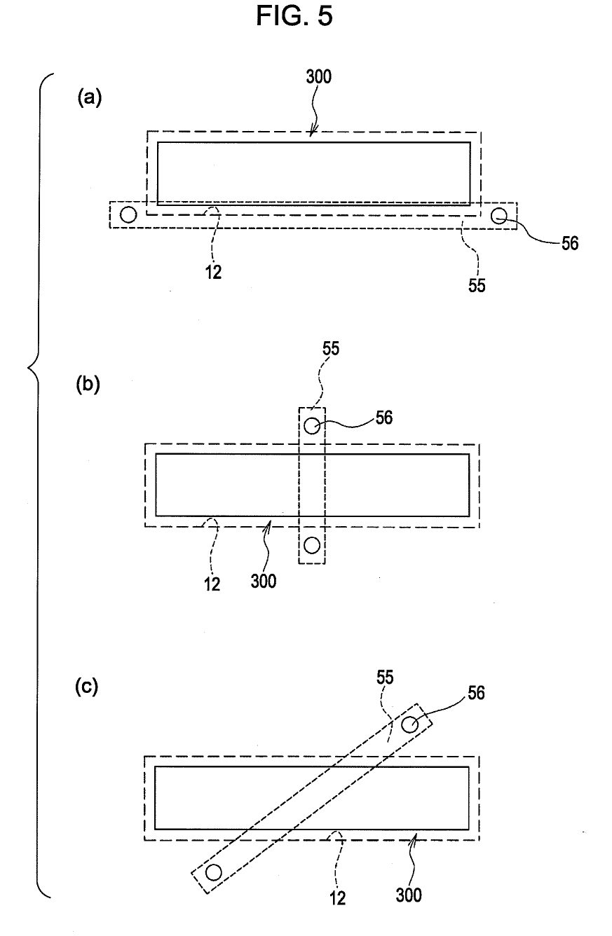

Although the diffusion layers 55 are formed in the width-direction central portions of the pressure generation chambers 12 in the longitudinal direction in the present embodiment, the formation positions of the diffusion layers 55 are not specially limited. For example, as shown in FIG. 5(a), the diffusion layers 55 may be formed in areas opposing one ends of the width direction of the pressure generation chambers 12. Since the vibration plates of the areas opposing the ends of the width direction of the pressure generation chambers 12 are relatively largely deformed by the driving of the piezoelectric elements 300, even when the diffusion layers 55 are provided in these portions, the detecting portion 202 can relatively easily detect the variations in resistance values of the diffusion layers 55.

The diffusion layers 55 may extend along the width direction of the pressure generation chambers 12 as shown in FIG. 5(b) and extend in an inclined direction of the pressure generation chambers 12 as shown in FIG. 5(c). Since the variation amounts of the resistance values of the diffusion layers 55 vary by the crystal plane orientation of the silicon substrate, the formation positions of the diffusion layers 55 need to be decided in consideration of this point. However, the detecting portion 202 can detect the variation in the resistance values of the diffusion layers 55 with certainty, by any configuration.

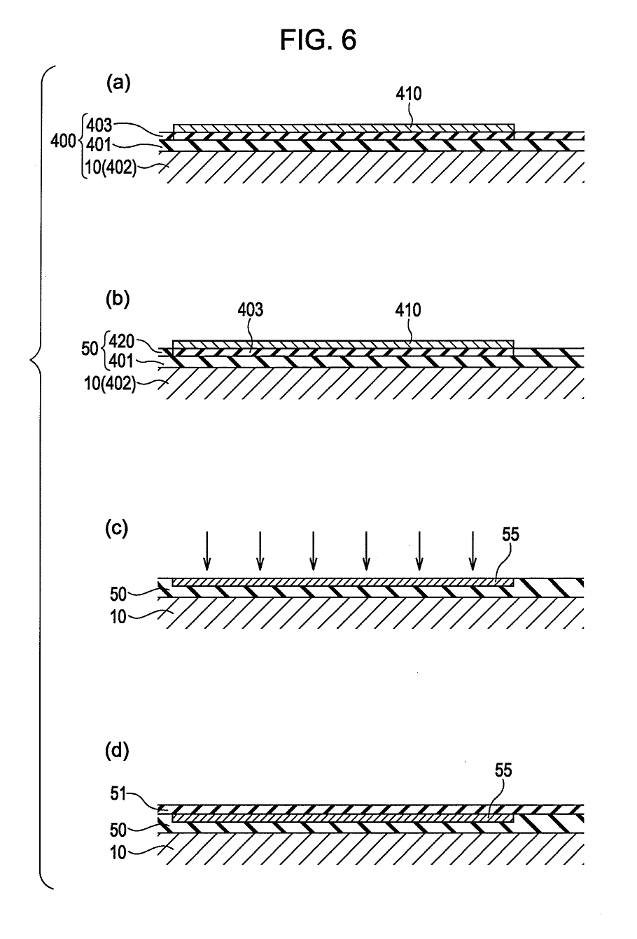

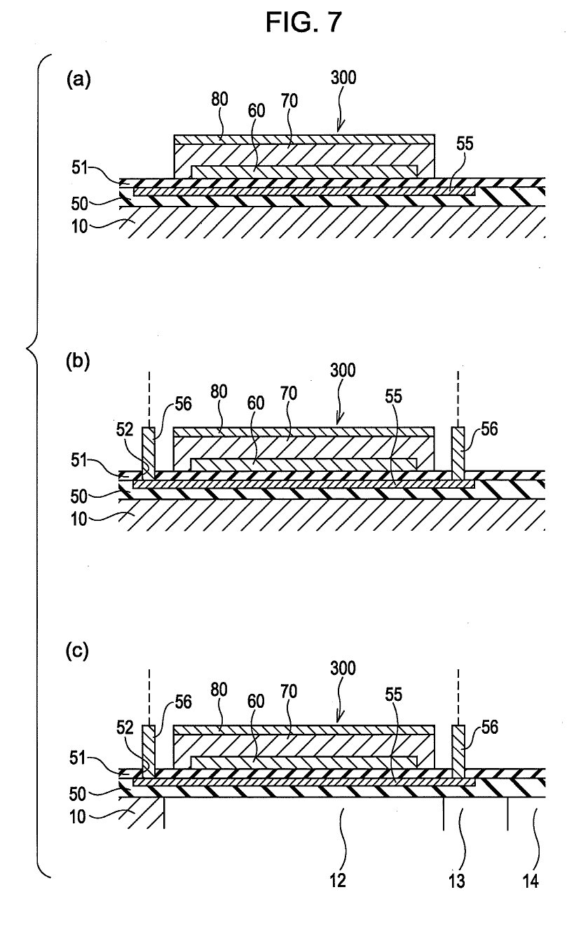

Hereinafter, a method of manufacturing such a liquid ejecting head will be described with reference to FIGS. 6 and 7. FIGS. 6 and 7 are views showing the method of manufacturing the liquid ejecting head and are cross-sectional views of each of the pressure generation chambers in the longitudinal direction.

In the following example, the head is manufactured using a SOI substrate 400 having silicon layers 402 and 403 formed of single crystal silicon at both sides of an insulating layer 401 formed of silicon dioxide, and one silicon layer (first silicon layer) 401 of the SOI substrate 400 is used as the channel forming substrate 10.

In detail, first, as shown in FIG. 6(a), a protective film 410 formed of, for example, silicon nitride, is formed on the whole surface of the second silicon layer 403 at the opposite side of the first silicon layer 402 which is the channel forming substrate 10 of the SOI substrate 400, and the protective film 410 is patterned so as to remain in the areas in which the diffusion layers 55 will be formed.

Next, as shown in FIG. 6(b), the elastic film 50 is formed by thermally oxidizing the surface of the SOI substrate 400 in a state in which the protective film 410 is formed. That is, a silicon dioxide layer 420 is formed in the second silicon layer 403 by thermal oxidization excluding a portion in which the protective film 410 is formed, and the elastic film 50 is formed by the concatenation of the insulating layer 401 with the silicon dioxide layer 420. In addition, the second silicon layer 403 of the portion, in which the protective film 410 is formed, remains without being thermally oxidized.

Next, as shown in FIG. 6(c), the protective film 410 is removed, and boron is doped into the remaining second silicon layer 403, which is not thermally oxidized, by ion implantation so as to form each of the diffusion layers 55. In addition, after boron is doped into the second silicon layer 403, it is preferable that the second silicon layer 403 is subjected to a heat treatment, for example, at 950 to 1050° C. Accordingly, boron (dopant) doped into the second silicon layer 403 is activated such that each of the diffusion layers 55 is suitably formed.

It is preferable that boron (B) is used as the dopant, but, for example, arsenic (As) or phosphorus (P) may be used. The dose amount need to be set such that the crystal of the second silicon layer 403 is not converted into amorphous form, but it is preferable that a peak concentration is 1.0×10¹⁹ (atoms/cm³) or more.

Next, as shown in FIG. 6(d), the insulating film 51 is formed on the elastic film 50 and each of the diffusion layers 55. In detail, a zirconium layer is formed on the elastic film 50 and each of the diffusion layers 55 by a sputtering method and this zirconium layer is then thermally oxidized at a predetermined temperature, thereby forming the insulating film 51 formed of zirconium oxide.

Next, as shown in FIG. 7(a), the lower electrode film 60, the piezoelectric layer 70 and the upper electrode film 80 are sequentially laminated on the insulating film 51 and are patterned, thereby forming each of the piezoelectric elements 300.

In addition, as the material of the piezoelectric layer 70, for example, in addition to a piezoelectric material such as lead zirconium titanate (PZT) or the like, relaxor ferroelectric which is obtained by adding metal such as niobium, nickel, magnesium, bismuth, yttrium or the like to this piezoelectric material, or the like may be used. The composition thereof is properly selected in consideration of the characteristics, the use, or the like the piezoelectric elements, but, for example, PbTiO₃(PT), PbZrO₃(PZ), Pb(ZrₓTi₁₋ₓx) O₃ (PZT) , Pb(Mg_{1/3} Nb_{2/3}) O₃—PbTiO₃ (PMN-PT), Pb(Zn_{1/3} Nb_{2/3}) O₃—PbTiO₃(PZN-PT), Pb(Ni_{1/3} Nb_{2/3}) O₃—PbTiO₃ (PNN-PT), Pb(In_{1/2} Nb_{1/2}) O₃—PbTiO₃(PIN-PT), Pb(Sc_{1/3} Ta_{2/3}) O₃—PbTiO₃(PST-PT), Pb(Sc_{1/3} Nb_{2/3}) O₃—PbTiO₃(PSN-PT), BiScO₃—PbTiO₃(BS-PT), BiYbO₃—PbTiO₃(BY-PT) or the like may be used. The method of forming the piezoelectric layer 70 is not specially limited, but, for example, in the present embodiment, the piezoelectric layer 70 was formed using a so-called sol-gel method of coating, drying and gelling so-called sol obtained by dissolving and dispersing a metal organic matter in a solvent and performing firing at a high temperature so as to obtain the piezoelectric layer 70 formed of metal oxide. The method of forming the piezoelectric layer 70 is not limited to the sol-gel method, and, for example, a metal-organic decomposition (MOD) method, a sputtering method, a physical vapor deposition (PVD) method such as a laser ablation method or the like may be used.

Next, as shown in FIG. 7(b), the fine holes (trenches) 52 are formed in the insulating film 51 of the areas opposing both ends of each of the diffusion layers 55 such that the connection wires 56 of which one end sides are connected to the detecting portion 202 of the control unit 200 are connected to the diffusion layers 55 in the fine holes 52.

Thereafter, although not shown, the reservoir forming substrate 30 is adhered to the surface of the SOI substrate 400, that is, the surface of the opposite side of the first silicon layer 402 which is the channel forming substrate 10, and the first silicon layer 402 which is the channel forming substrate 10 is anisotropically etched (wet etched) until reaching the elastic film 50 using, for example, an alkali solution such as KOH or the like, thereby forming the channels of the pressure generation chambers 12 as shown in FIG. 7(c). In addition, the liquid ejecting head is manufactured by adhering the nozzle plate 20 to the channel forming substrate 10 in which the pressure generation chambers 12 are formed (see FIG. 2).

Actually, a plurality of channel forming substrates 10 is integrally formed in one wafer and a plurality of liquid ejecting heads is manufactured by finally dividing the wafer.

### Embodiment 2

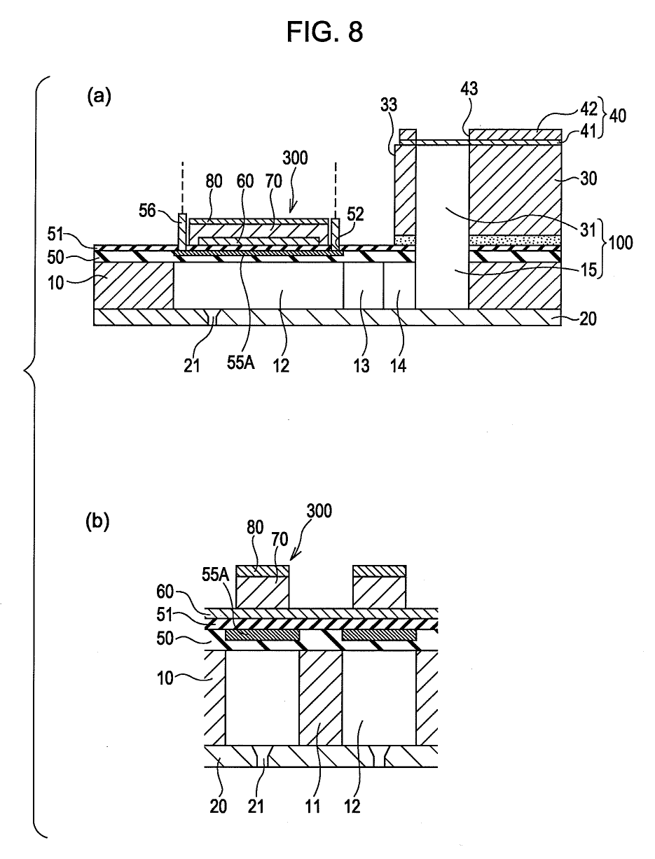

FIG. 8 is a cross-sectional view of a liquid ejecting head according to Embodiment 2 of the invention. The present embodiment is an example in which the shape of the diffusion layers is changed. In detail, as shown in FIG. 8, the present embodiment is equal to Embodiment 1 except that diffusion layers 55A are formed to have the substantially same shape as that of the openings of the pressure generation chambers 12.

Even in such a configuration, it is possible to uniformize the displacement amounts of the vibration plates and to uniformize the ejection characteristics of the ink droplets, by detecting the variations in resistance values of the diffusion layers 55A and adjusting the voltages applied to the piezoelectric elements 300 according to the detected result.

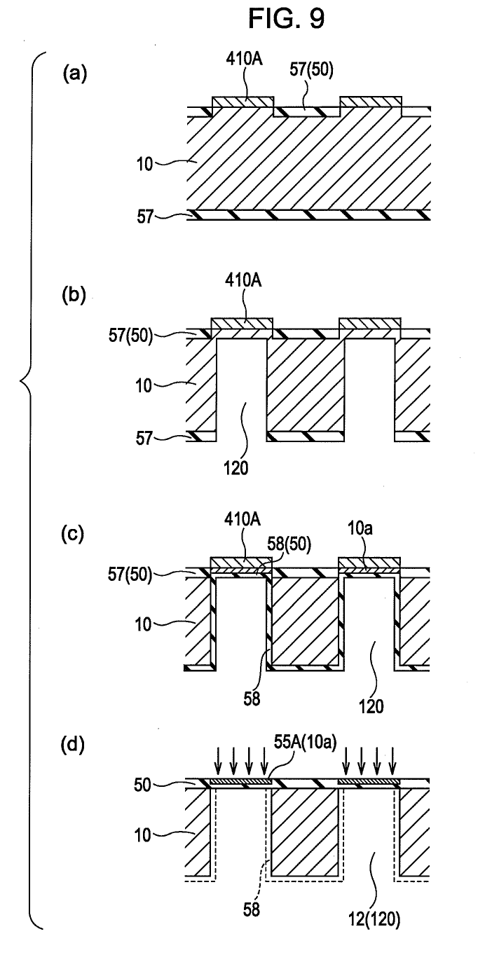

The method of manufacturing the liquid ejecting head according to the present embodiment is not specially limited, and the liquid ejecting head may be formed by the same manufacturing method as Embodiment 1. When the pressure generation chambers 12 can be formed before the piezoelectric elements 300 are formed, for example, the liquid ejecting head may be manufactured by the following manufacturing method. In addition, FIG. 9 is a view showing a method of manufacturing a liquid ejecting head according to Embodiment 2 of the invention and is a cross-sectional view of each of the pressure generation chambers in the width direction.

First, as shown in FIG. 9(a), a protective film 410A formed of silicon nitride or the like is formed on one surface of the channel forming substrate 10 which is a silicon substrate. This protective film 410A is formed so as to cover the areas in which the pressure generation chambers 12 of the channel forming substrate 10 are formed. In addition, in a state in which the protective film 410A is formed, the channel forming substrate 10 is thermally oxidized so as to form a silicon dioxide film 57, which becomes the elastic film 50, on the surfaces of the channel forming substrate 10.

Next, as shown in FIG. 9(b), the silicon dioxide film 57 formed on the other surface of the channel forming substrate 10 is patterned, and the channel forming substrate 10 is anisotropically etched using the silicon dioxide film 57 as a mask, thereby forming concave portions 120 in the channel forming substrate 10. At this time, by controlling an etching time, the concave portions 120 are formed with a predetermined depth such that the bottoms of the concave portions 120 are substantially matched to the boundary surface with the silicon dioxide film 57. In addition, the concave portions 120 are formed with a width and length slightly smaller than those of the pressure generation chambers 12.

Next, the silicon dioxide film 57 of the other surface side of the channel forming substrate 10 is removed and, as shown in FIG. 9(c), the channel forming substrate 10 is then thermally oxidized again so as to form a silicon dioxide film 58 on the inner surfaces of the concave portions 120. At this time, the silicon dioxide film 58 formed on the bottoms of the concave portions 120 is concatenated with the silicon dioxide film 57 formed by the above-described process so as to form the elastic film 50. In addition, the channel forming substrate 10a of the portion, in which the protective film 410A is formed, remains outside the silicon dioxide film 58, without being thermally oxidized.

Next, as shown in FIG. 9(d), the protective film 410A is removed and, at the same time, the silicon dioxide film 58 is removed excluding the bottoms of the concave portions 120, that is, the portions configuring the elastic film 50. As the result of removing the silicon dioxide film 58 of the side surface portions of the concave portions 120, the pressure generation chambers 12 having a predetermined width and length slightly larger than those of the concave portions 120 are formed. In the present embodiment, since the pressure generation chambers 12 are formed by removing the silicon dioxide film 58 of the side surfaces of the concave portions 120, the width and length of the concave portions 120 need to be properly set according to the thickness of the silicon dioxide film 58 formed by thermal oxidation.

Thereafter, boron is doped into the channel forming substrate 10a, which remains on the elastic film 50 without being oxidized, by ion implantation so as to form the diffusion layers 55A. After the elastic film 50 and the diffusion layers 55A are formed, the layers of the insulating film 51 and the piezoelectric elements 300 are formed as described above.

By employing such a manufacturing method, it is possible to manufacture the liquid ejecting head without using the SOI substrate. Accordingly, it is possible to reduce manufacturing cost and to manufacture the liquid ejecting head with relatively low cost.

### Embodiment 3

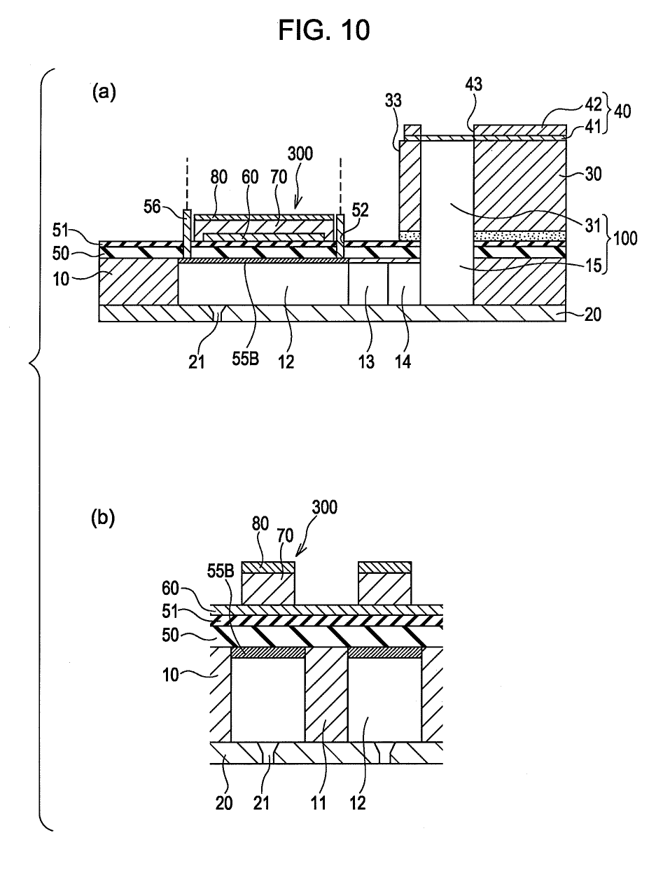

FIG. 10 is a cross-sectional view of a liquid ejecting head according to Embodiment 3 of the invention. The present embodiment is a modified example of the diffusion layer. While the diffusion layers 55 are provided between the elastic film 50 and the insulating film 51 in the above-described embodiment, the present embodiment is an example in which diffusion layers 55B are formed at the side of the pressure generation chambers 12 rather than the elastic film 50, as shown in FIG. 10. The other configuration is equal to that of Embodiment 2.

Even in such a configuration, it is possible to uniformize the displacement amounts of the vibration plates and to uniformize the ejection characteristics of the ink droplets, by detecting the variations in resistance values of the diffusion layers 55B and adjusting the voltages applied to the piezoelectric elements 300 according to the detected result.

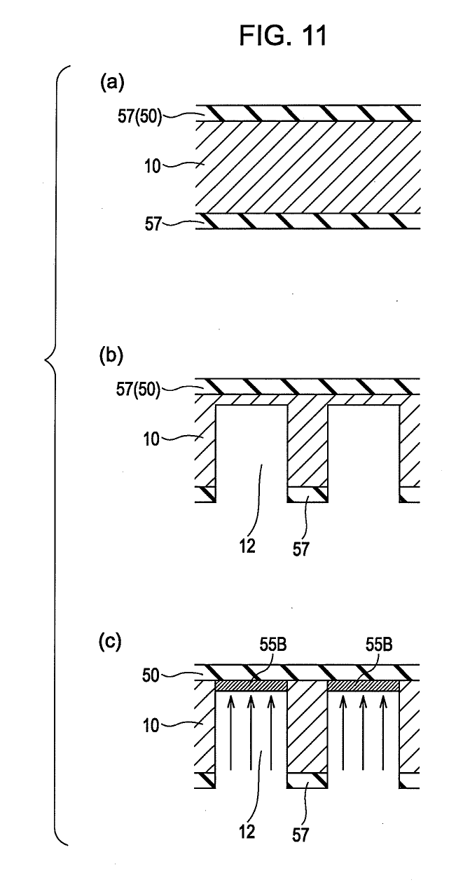

The method of manufacturing the liquid ejecting head according to the present embodiment is not specially limited, and, for example, the liquid ejecting head may be manufactured by the following manufacturing method. FIG. 11 is a view showing a method of manufacturing a liquid ejecting head according to Embodiment 3 of the invention and is a cross-sectional view of each of the pressure generation chambers in the width direction.

First, as shown in FIG. 11(a), the channel forming substrate 10 which is a silicon substrate is thermally oxidized so as to form a silicon dioxide film 57, which becomes the elastic film 50, on the surfaces thereof. Next, as shown in FIG. 11(b), the silicon dioxide film 57 formed on the other surface of the channel forming substrate 10 is patterned, and the channel forming substrate 10 is anisotropically etched using the silicon dioxide film 57 as a mask, thereby forming the pressure generation chambers 12 in the channel forming substrate 10. At this time, an etching time is controlled such that the etching is not performed until reaching the silicon dioxide film 57 (elastic film 50), and thus the channel forming substrate 10 remains on the bottom portions of the pressure generation chambers 12 with a predetermined thickness.

Next, as shown in FIG. 11(c), boron is doped from the opening sides of the pressure generation chambers 12 into the channel forming substrate 10 of the bottom portions of the pressure generation chambers 12 by ion implantation so as to form the diffusion layers 55B. Accordingly, the diffusion layers 55B are formed on the elastic film 50 at the side of the pressure generation chambers 12. Thereafter, the layers of the insulating film 51 and the piezoelectric elements 300 are formed as described in Embodiment 1.

### Other Embodiments

Although the embodiments of the invention are described, the invention is not limited to the above-described embodiments. For example, although the detecting portion 202 detects the resistance values of the diffusion layers 55 in the above-described embodiments, the resistance values itself do not need to be necessarily measured. For example, the current values of the diffusion layers 55 may be measured and the variations in resistance values may be calculated from the measured result. For example, although the diffusion layers 55 are formed, that is, the impurities are doped, in the method of manufacturing the head in the above-described embodiments, the impurities may be doped into a predetermined portion in advance when the SOI substrate or the silicon substrate is formed.

Although the thin-film type piezoelectric elements 300 are described as the pressure generation elements for causing variations in pressure in the pressure generation chambers 12 in the present embodiment, the pressure generation elements are not specially limited. For example, a thick-film type actuator apparatus formed by a method of adhering a green sheet, a vertical vibration type actuator apparatus for alternately laminating a piezoelectric material and an electrode forming material so as to expand or contract in an axial direction or the like may be used. In addition, a so-called electrostatic actuator for generating static electricity between the vibration plates and the electrodes, deforming the vibration plates by static electricity force, and ejecting liquid droplets from the nozzle openings, or the like may be used.

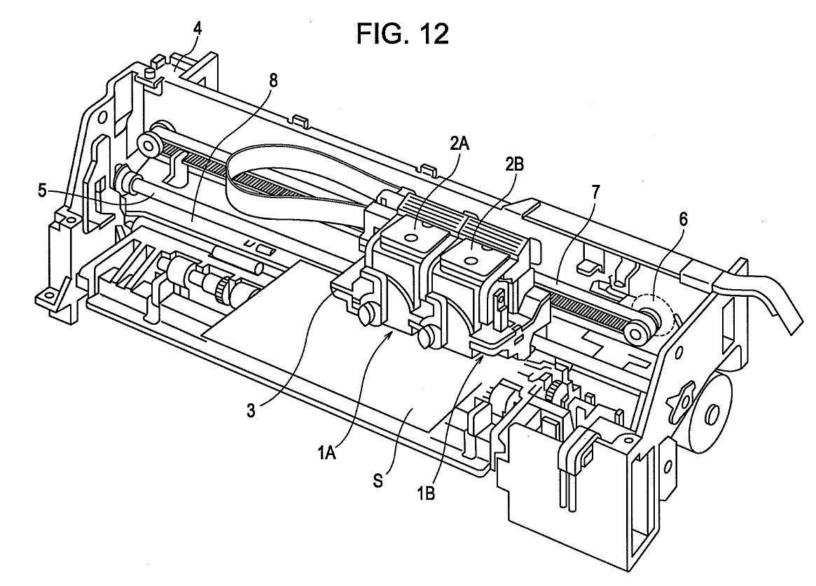

Such a liquid ejecting head configures a portion of a recording head unit including ink channels communicating with ink cartridges or the like so as to be mounted in a liquid ejecting apparatus. FIG. 12 is a schematic view showing an example of the liquid ejecting apparatus. As shown in FIG. 12, cartridges 2A and 2B configuring an ink supply unit are detachably mounted in the recording head units 1A and 1B each having the liquid ejecting head, and a carriage 3 in which the recording head units 1A and 1B are mounted is axially movably provided on a carriage shaft 5 mounted in an apparatus main body 4. The recording head units 1A and 1B eject, for example, a black ink composition and a color ink composition, respectively.

A driving force of a driving motor 6 is delivered to the carriage 3 via a plurality of gears (not shown) and a timing belt 7, and the carriage 3 in which the recording head units 1A and 1B are mounted is moved along the carriage shaft 5. In the apparatus main body 4, a platen 8 is provided along the carriage shaft 5, and a recording sheet S which is a recording medium such as paper feed by a feed roller (not shown) or the like is transported on the platen 8.

Although the liquid ejecting head is described as an example of the liquid ejecting head in the above-described example, the invention relates to general liquid ejecting heads and is applicable to a method of manufacturing a liquid ejecting head for ejecting a liquid excluding an ink. The other liquid ejecting heads may, for example, include: various kinds of recording heads used in an image recording apparatus such as a printer; coloring material ejecting head used for manufacturing color filters of a liquid crystal display and the like; an electrode material ejecting head used for forming electrodes of an organic EL display, a field emission display (FED) and the like; a bio-organic matter ejecting head used for manufacturing biochips; and the like.

1. A liquid ejecting head comprising:
a channel forming substrate in which pressure generation chambers communicating with nozzles for ejecting liquid droplets are provided;
vibration plates provided on the channel forming substrate so as to configure one surfaces of the pressure generation chambers;
pressure generation elements which displace the vibration plates and apply pressure to the insides of the pressure generation chambers;
diffusion layers provided in areas opposing the pressure generation chambers by doping impurities into a portion of the channel forming substrate;
a detecting portion which detects variations in resistance values of the diffusion layers due to the deformation of the vibration plates; and
an adjustment portion which adjusts driving voltages applied to the pressure generation elements on the basis of the detected result of the detecting portion.

2. The liquid ejecting head according to claim 1, wherein the diffusion layers are provided along the longitudinal direction of the pressure generation chambers.

3. The liquid ejecting head according to claim 1, wherein the diffusion layers are provided in the width-direction central portions of the pressure generation chambers.

4. The liquid ejecting head according to claim 1, wherein the diffusion layers extend from the areas opposing the pressure generation chambers to the outsides of the pressure generation chambers, and the detecting portion is connected to the portions of the diffusion layers at the outside of the pressure generation chambers.

5. The liquid ejecting head according to claim 1, wherein, when the vibration plates include a plurality of insulating layers formed of an insulating material, the diffusion layers are provided between the insulating layers.

6. The liquid ejecting head according to claim 1, wherein, when the vibration plates include an elastic film formed by thermally oxidizing a silicon substrate, the diffusion layers are provided on the elastic film at the side of the pressure generation chambers.

7. The liquid ejecting head according to claim 1, wherein the pressure generation elements are piezoelectric elements each having a piezoelectric layer formed of a piezoelectric material.

8. A liquid ejecting apparatus comprising the liquid ejecting head according to claim 1.
